(19) United States
(12) Patent Application Publication
(10) Pub. No.: US 2012/0188474 A1
(43) Pub. Date: Jul. 26, 2012

(54) THERMAL IMAGER

(75) Inventors: Robert K. Reich, Tyngsborough, MA (US); Harry R. Clark, Townsend, MA (US)

(73) Assignee: Massachusetts Institute of Technology, Cambridge, MA (US)

(21) Appl. No.: 13/192,523

(22) Filed: Jul. 28, 2011

Related U.S. Application Data
(60) Provisional application No. 61/378,998, filed on Sep. 1, 2010.

(51) Int. Cl. G02F 1/13357

(52) U.S. Cl. 349/22

(57) ABSTRACT

The imager includes a lens for focusing infrared light forming a thermal image onto a liquid crystal array thereby changing the temperature of the liquid crystals to alter a physical property of the liquid crystals. A source of visible polarized light is arranged to illuminate the liquid crystal array so that the polarization of light reflected from the liquid crystal array varies with changes in temperature of the liquid crystals. A cross polarizer receives and transmits therethrough the light reflected from the liquid crystal array, the cross polarizer adapted to change the intensity of the light. An imager receives and detects the change in intensity of the light from the cross polarizer so that the thermal image is recreated as an electronic signal. In a preferred embodiment, the physical property is index of refraction and the liquid crystal array includes birefringent nematic liquid crystals.

This application claims priority to provisional application Ser. No. 61/378,998 filed on Sep. 1, 2010, the contents of which are incorporated herein by reference in their entirety.

This invention was made with government support under contract number FA8721-05-C-0002, awarded by the US Air Force. The government has certain rights in the invention.

### BACKGROUND OF THE INVENTION

This invention relates to thermal detectors, and more particularly to an uncooled thermal detector based on liquid crystals and silicon process technologies.

Imaging at wavelengths greater than 1.1 μm (infrared imaging) is important for military and commercial applications. Thermal imagers may be cooled or uncooled. Cooled thermal imagers, such as those based on an exotic material such as mercury cadmium telluride (HgCdTe), must be cooled to cryogenic temperatures, and the imaging device itself is made of expensive and toxic materials. Cooled detectors have the highest sensitivity but suffer from size, weight and power constraints and technology saturation as pixel counts are not increasing.

Uncooled thermal detectors are increasingly important for such military applications as tactical day and night imaging; commercial applications include firefighting, search and rescue missions, medical diagnoses and night-time driving.

Present uncooled thermal imagers are limited in format (less than one Mpixel) and sensitivity. State-of-the-art uncooled microbolometers are based on thermistors whose performance (resolution and sensitivity) has progressed slowly over the past few years, translating directly into high cost. Bolometers require complex fabrication methods and to date cannot deliver the resolution that CCDs or CMOS imagers routinely supplied over a decade ago.

Liquid crystals were investigated for thermal imaging in the 1970s [1], but the technologies did not exist or were not available to make an optical integrated thermal imager. In particular, microelectromechanical machines (MEMs) processes had not been invented, solid-state-imagers had just been invented and were not of the size or format needed, and light emitting diodes were relatively inefficient. Other optical techniques have been explored by others [2, 3]. The numbers in brackets refer to the references included herewith. The contents of all of these references are incorporated herein by reference in their entirety. These techniques have suffered from a combination of low sensitivity, high noise, non-uniform pixel response, and difficult fabrication processes.

It is therefore an object of the present invention to provide an improved uncooled thermal imager.

### SUMMARY OF THE INVENTION

The thermal detector according to the invention includes a lens for focusing infrared light forming a thermal image onto a liquid crystal array, thereby changing the temperature of the liquid crystals to alter a physical property of the liquid crystals. A source of visible light is arranged to illuminate the liquid crystal array which changes the light intensity reflected or transmitted from the liquid crystal array with changes in temperature of the liquid crystals. For an example case using polarized light, a cross polarizer is provided to receive and transmit therethrough the light from the liquid crystal array, the cross polarizer adapted to change the intensity of the light. The signal can be viewed directly with an eye or sent to an imager that receives and detects the change in intensity of the tight from the cross polarizer whereby the thermal image is recreated as an electronic signal. In an example embodiment, the physical property is index of refraction but other liquid crystal properties can be used such as light scattering or molecular twist pitch change as in cholesterics. Also in this example embodiment the liquid crystal array includes birefringent nematic liquid crystals. However, a variety of other liquid crystal metaphases are envisioned to be possible such as cholesterics, blue phase and various smectic phases. The imager may be a charge coupled device or a CMOS active pixel sensor.

In another preferred embodiment, the liquid crystals include a substrate, a low thermal conductance leg extending from the substrate, an absorber layer and a liquid crystal layer. A suitable absorber layer is nickel or to simplify the pixel the liquid crystal can be fabricated to also be the absorber. The thermal imager of the invention is particularly adapted for light in the mid- to long-wavelength spectrum. In particular, suitable ranges are 3-5 μm and 8-12 μm. A display may be provided for displaying still pictures or videos from the electronic signal.

### BRIEF DESCRIPTION OF THE DRAWING

FIG. 1 is a schematic illustration of an embodiment of the invention.

FIG. 2 is a schematic illustration of another embodiment of the invention.

FIGS. 3a-3f are schematic illustrations of the process flow for microbolometer fabrication

### DESCRIPTION OF THE PREFERRED EMBODIMENT

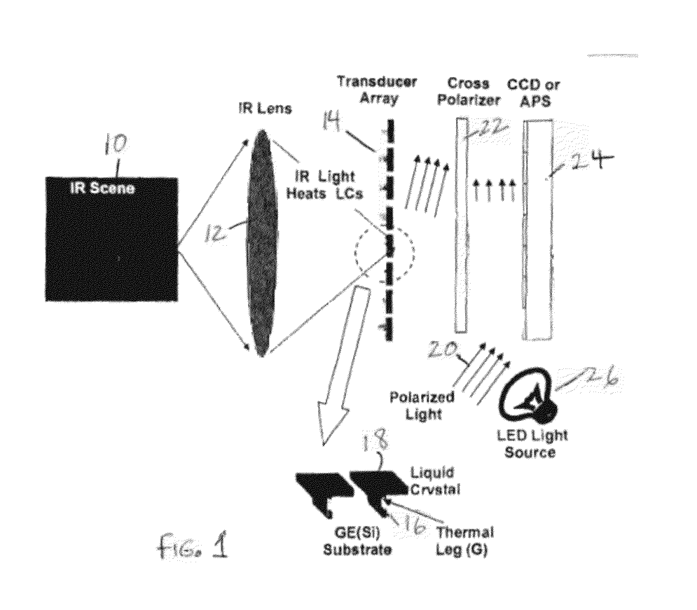

With reference to FIG. 1, infrared light from an infrared scene 10 is focused by an infrared lens 12 onto a transducer array 14. The transducer array 14 includes a substrate, a low thermal conductance leg 16, an absorber layer such as nickel and an LC layer 18. The absorber layer could be the liquid crystal layer 18 which might make the pixel more efficient in terms of response time and a simpler pixel architecture. The infrared light is absorbed by the pixel changing the temperature of the liquid crystal. The temperature change causes physical properties (index of refraction, liquid crystal molecule pitch or scattering of light) of the liquid crystal to be altered. In this embodiment, the liquid crystal is a birefringent nematic liquid crystal and the index of refraction is changing. Visible polarized light 20 illuminates the transducer array 14. Light reflected by the liquid crystal layer 18 changes polarization as a function of the liquid crystal temperature. The light then passes through a cross polarizer 22 resulting in a change in intensity. The change in intensity is detected by a silicon solid-state imager 24 such as a CCD or CMOS active pixel sensor (APS). Thus the thermal scene 10 image is recreated as an electronic signal in the solid-state imager 24.

The optical response near the phase change of liquid crystals is highly temperature dependent. Incident infrared radiation will cause a temperature change in the liquid crystal material 18 thus inducing a change in polarization in the visible light transmitted or reflected from the liquid crystal. By employing a visible light source 26 the reduction or enhancement of the light transmission will be detected by a visible light imager 24 thus generating a profile of the incident infrared light. While a single light source is shown in the figure, multiple light sources operating at different wavelengths can be used to increase the dynamic range. The advance of LED technology has made compact and efficient multiple wavelength light sources possible.

The present invention will enable silicon-based CCDs or CMOS imagers to produce images of an infrared scene using the unique thermal-to-optical liquid crystal transducer disclosed herewithin. The invention uses the rich technological advantages of silicon-based microelectronics along with the advantages of decades-long research into perfecting silicon based imaging in the visible part of the electromagnetic spectrum.

The present invention thus leverages the ever-expanding visible imager technology that is inexpensive and high resolution. Further, by separating the thermal infrared-to-optical transducer from the solid-state imager readout, the transducer pixel arrays can be better optimized for detecting the infrared signal. This invention will enable mid- to long-wavelength light to be converted to an electronic image based on the manipulation of the incoming radiation and subsequent conversion or altering of a secondary light source incident on the solid-state imager.

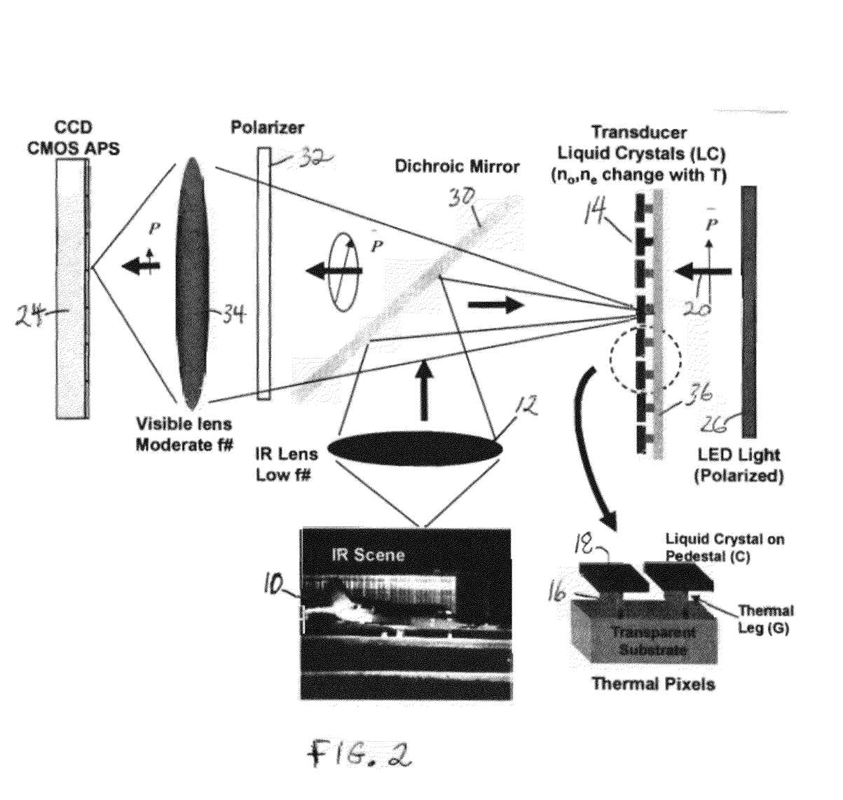

Another embodiment of the invention is shown in FIG. 2. Many of the elements in FIG. 2 are similar to those in FIG. 1, Infrared light from an infrared scene 10 passes through an infrared lens 12 and is reflected by a dichroic mirror 30 onto a liquid crystal transducer 14 thereby heating the pixels 18 resting on the thermal legs 16. Polarized light 20 from a LED light source 26 passes through the transducer 14 that includes a transparent substrate 36. The light from the transducer 14 passes through the dichroic mirror 30 and through a polarizer 32 and is focused by a visible light lens 34 onto a charge coupled device 24. Thus, the infrared scene 10 is now replicated in visible light and detected by the sensor 24. The charge coupled device 24 can be replaced by a human eye for a direct view embodiment.

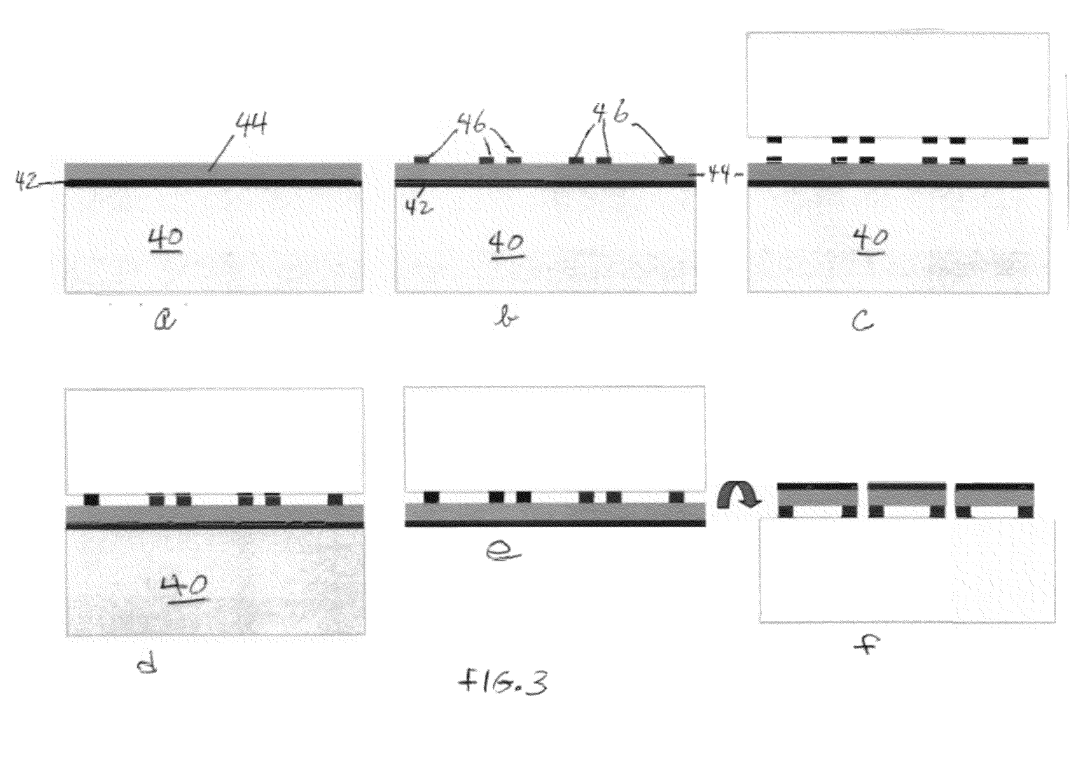

With reference now to FIG. 3, an example process flow based on microbolometer fabrication will now be described. In FIG. 3a, a quartz substrate 40 has an oxide layer 42 and a nitride layer 44 deposited thereon. Thereafter, as shown in FIG. 3b, air isolation posts 46 are deposited and patterned. Low temperature oxide wafer bonding is shown in FIG. 3c and the bonded wafer pair is shown in FIG. 3d. The substrate 40 is then removed as shown in FIG. 3e followed by pixilation as shown in FIG. 3f.

It is recognized that modifications and variations of the present invention will be apparent to those of ordinary skill in the art and it is intended that all such modifications and variations be included within the scope of the appended claims.

### REFERENCES

1. R. D. Ennulat, L. E. Garin. and J. D. White “The Temperature Sensitivity of Selective Reflection by Cholesteric Mesophases and Its possible Limitations”, Mol. Cryst. Liq. Cryst., Vol. 26, 1974.
2. P. G. Datskosa, N. V. Lavrik, and S. Rajic “Performance of Uncooled Microcantilever Thermal Detectors,” Review of Scientific Instrumentation, Vol. 75, No. 4, April 2004.
3. M. Wagner, F. Ma, J. Heanue and S. Wu “Solid State Optical Thermal Imagers.” Infrared Technology and Applications XXXIII, Proc. Of SPIF. Vol. 6542.2007.

What is claimed is:

1. Thermal imager comprising:
a lens for focusing infrared light forming a thermal image onto a liquid crystal array thereby changing the temperature of the liquid crystals to alter a physical property of the liquid crystals;
a source of visible light arranged to illuminate the liquid crystal array wherein a property of light reflected or transmitted from the liquid crystal array varies with changes in temperature of the liquid crystals;
an analyzer to receive and transmit through the light reflected or transmitted from the liquid crystal array, the analyzer adapted to change the intensity of the light; and
an imager for receiving and detecting the change in intensity of the light from the cross polarizer, whereby the thermal image is recreated as an electronic signal.

2. The thermal imager of claim 1 wherein the physical property is the index of refraction.

3. The thermal imager of claim 1 wherein the liquid crystal array includes birefringent nematic liquid crystals.

4. The thermal imager of claim 1 wherein the imager is a charge coupled device or a CMOS active pixel sensor.

5. The thermal imager of claim 1 wherein the liquid crystals comprise a substrate, a low conductance leg extended from the substrate, an absorber layer and a liquid crystal layer.

6. The thermal imager of claim 5 wherein the absorber layer is nickel.

7. The thermal imager of claim 1 wherein the infrared light is mid- to long-wavelength light.

8. The thermal imager of claim 7 wherein the mid-wavelength light is in the range of 3-5 μm and the long wavelength light is in the range of 8-12 μm.

9. The thermal imager of claim 1 further including a display for displaying still pictures or videos from the electronic signal.

10. The thermal imager of claim 1 wherein the liquid crystal array is made by a VLSI silicon process technology.

11. The thermal imager of claim 1 wherein the imager is an eye.

12. The thermal imager of claim 1 further including an additional layer to thermally stabilize the liquid crystal layer.

13. The thermal imager of claim 5 wherein the liquid crystal layer is also the absorber layer.

14. The thermal imager of claim 1 further including means for applying an electric field to lower light scattering noise.

15. The thermal imager of claim 1 including multiple light sources operating at different wavelengths.

16. The thermal imager of claim 1 wherein the liquid crystals detect infrared light by scattering the light.

17. The thermal imager of claim 1 wherein the liquid crystals detect the infrared signal by changing molecular pitch.

18. The thermal imager of claim 1 including a detector that does proximity imaging not requiring an infrared lens.
